(19) United States
(12) Patent Application Publication
(10) Pub. No.: US 2003/0128005 A1
(43) Pub. Date: Jul. 10, 2003

(54) Power window control mechanism

(76) Inventors: John C. Sodano, Carlsbad, CA (US); Freeman J. Thomas, Carlsbad, CA (US)

Correspondence Address: Ralph E. Smith, DaimlerChrysler Intellectual Capital Corporation, CIMS 483-02-19, 800 Chrysler Drive, Auburn Hills, MI, 48326-2757, US

(21) Appl. No.: 10/324,475

(22) Filed: Dec. 20, 2002

Related U.S. Application Data
(60) Provisional application No. 60/343,356, filed on Dec. 21, 2001.

(51) Int. Cl. G05D 3/00

(52) U.S. Cl. 318/466

(57) ABSTRACT

A control arrangement is provided for a power window in a vehicle. The control arrangement includes a window regulator mechanism configured to move a window between fully-open and fully-closed positions, and a switch having a input member that is translatable by an occupant in the vehicle between respective end positions. The switch is arranged to produce a signal indicative of the relative position of the translatable input member. A controller is coupled to the switch and the window regulator mechanism, and is configured to control operation of the window regulator mechanism in response to the switch signal such that window is moved to a position correlated to the relative position of the translatable input member.

### CROSS REFERENCE TO RELATED APPLICATIONS

This application claims the benefit of U.S. Provisional Application No. 60/343,356, filed on Dec. 21, 2001.

The present invention generally relates to mechanisms for controlling an automotive power window.

### BACKGROUND OF THE INVENTION

Generally, power window arrangements for vehicles utilize at least one occupant actuated switch positioned within the vehicle to control bi-directional operation of a window motor to position the window to a desired open/closed position. While such power window arrangements have gained widespread acceptance in the marketplace, the aforementioned switch operation generally require the occupant to maintain actuation of the switch (i.e., button, knob, lever, etc.) until the window has reached the desired position. While some power systems have been adapted to allow one-touch actuation of a switch to cause a window to automatically move to a full open position, such systems still require the user to maintain switch actuation for any other operation of the window motor. Accordingly, what is needed is a power window control arrangement which will allow a user to select any desired open/closed window position without need for the user to continually maintain actuation of a corresponding control switch.

### SUMMARY OF THE INVENTION

Therefore, in accordance with one aspect of the present invention, a vehicle window position control arrangement is provided having a slidable or rotatable switch mechanism arranged such that translation of the switch causes automatic positioning of a vehicle window to a corresponding position.

In accordance with another aspect of the invention, a “set and forget” power window control arrangement is provided for a vehicle such that positioning of a vehicle window is controlled to correlate to the position of a slidable switch mechanism located within the vehicle.

In accordance with these and other aspects, the present invention provides a control arrangement for a power window in a vehicle including a window regulator mechanism having at least one motor and a structure that is configured to move a window between fully-open and fully-closed positions, and a switch having a input member that is translatable by an occupant in the vehicle between respective end positions. The switch is arranged to produce a signal indicative of the relative position of the translatable input member. A controller is coupled to the switch and the window regulator mechanism, and is configured to control operation of the window regulator mechanism in response to the switch signal such that window is moved to a position correlated to the relative position of the translatable input member.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

Additional advantages and features of the present invention will become apparent from the subsequent description and the appended claims, taken in conjunction with the accompanying drawings, wherein:

FIG. 1 is a diagram a vehicle with a window control arrangement in accordance with the present invention;

FIG. 2 is a diagram showing a sliding window control switch in accordance with an exemplary embodiment of the present invention;

FIG. 3 is a schematic representation of the window control arrangement of FIG. 1; and

FIG. 4 is a diagram representing operation of a window in correlation to position of a slidable control switch.

### DETAILED DESCRIPTION OF THE PREFERRED EMBODIMENT(S)

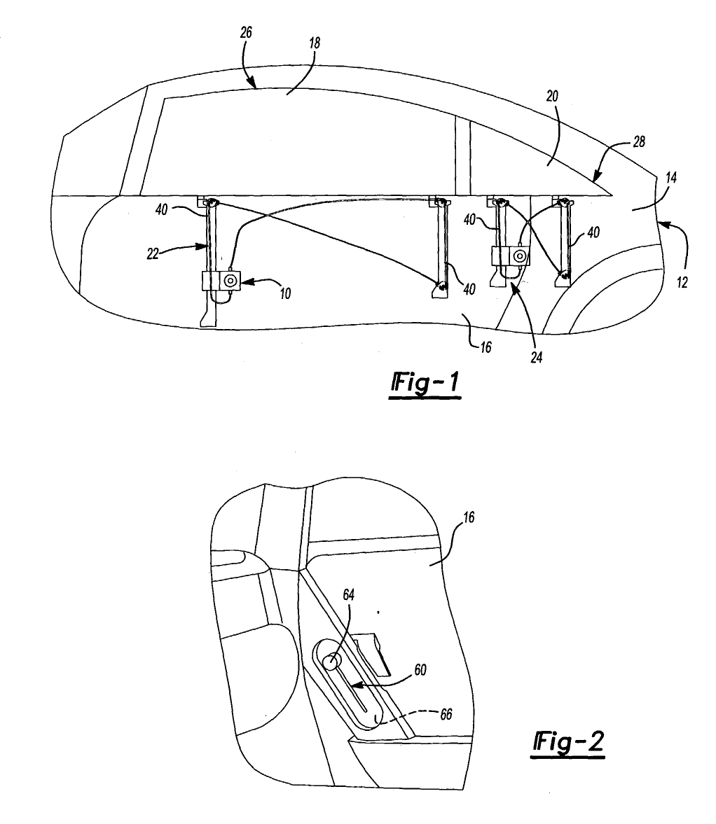

With reference to FIGS. 1, 2, and 3 of the drawings, a vehicle power window control arrangement 10 is shown in accordance with the present invention is. A portion of the vehicle is denoted at 12, and includes a body 14, a door 16, a first window pane 18, a second window pane 20, a first window regulator 22 and a second window regulator 24. The body 14 and the door 16 cooperate to define a window aperture 26 and a second window aperture 28.

The first window regulator 22 is coupled to the door 16 and the first window pane 18 in a conventional manner and is operable for selectively raising and lowering the first window pane 18 between a raised position, which substantially closes window aperture 26, and a lowered position, which substantially clears window aperture 26. Likewise, the second window regulator 24 is coupled to the body 14 and the second window pane 20 in a conventional manner and is operable for selectively raising and lowering the second window pane 20 between a raised position, which substantially closes window aperture 28, and a lowered position, which substantially clears window aperture 28.

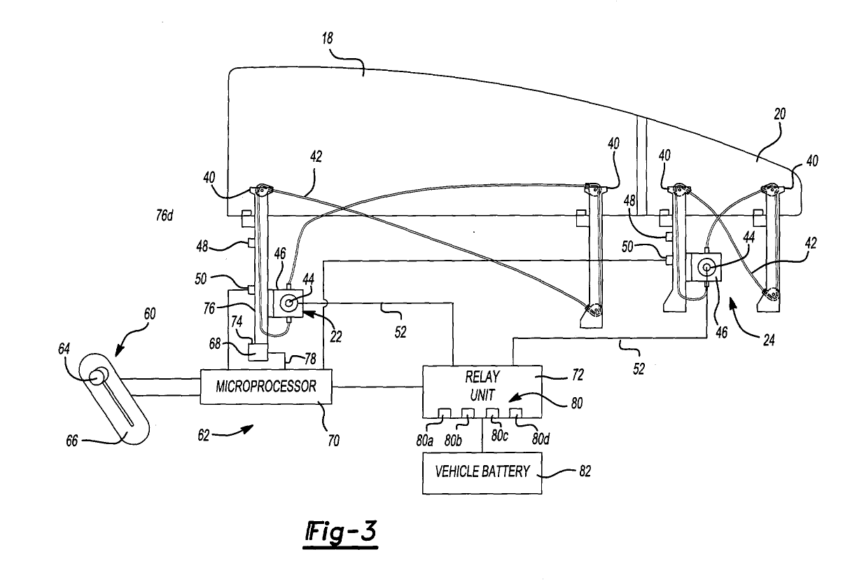

As best seen in FIG. 3, each of the first and second window regulators 22 and 24 includes a pair of guide rails 40, a cable 42, a drum 44, a drive motor 46, an upper limit switch 48 and a lower limit switch 50. The guide rails 40 are mounted to an appropriate structure, such as the door 16 or the body 14, to guide an associated window panel between the raised and lowered positions. The cable 42 is festooned through the guide rails 40 and secured to the drum 44 such that rotation of the drum 44 applies tension to a first end of the cable 42 and rotation of the drum 44 in an opposite rotational direction applies tension to a second end of the cable 42. In an exemplary embodiment, motor 46 is bidirectional having a rotatable output shaft (not specifically shown) that is coupled to the drum 44. The motor can be fixedly coupled to the guide rails 40. The upper and lower limit switches 48 and 50 are coupled to the guide rails 40 and are operable for generating an upper and lower limit switch signals, respectively, responsive to the movement of the window pane to the raised and lowered positions, respectively. A wire harness 52 electrically couples the motor 46 to the window control mechanism 10.

With specific reference to FIG. 3, the window control mechanism 10 is schematically illustrated to include a variable output type switch (dimmer switch) in the form of a slider rheostat switch 60, and a controller 62. The slider rheostat switch 60 can be a commercially available sliding rheostat that produces an input switch signal having a voltage that varies according to the position or displacement of the switch knob 64 relative to a track in the switch housing 66. Alternatively, the switch mechanism could be implemented as a variable output type switch (dimmer switch) device having a rotary dial/knob mechanism. In the exemplary embodiment illustrated, the controller 62 includes a cable pull potentiometer 68, which is also known as an analog output position transducer, a microprocessor 70, and a relay unit 72 for distributing power via the wire harness 52 to the motor 46. It will be understood that cable pull potentiometers are devices that are well known in the art. The cable pull potentiometer 68 includes a housing 74, a retractably biased cable 76 and a wire harness 78. The cable pull potentiometer 68 is operable for generating a cable displacement signal that is indicative of an amount by which the cable 76 has been withdrawn from the housing 74. The housing 74 is fixedly coupled to the guide rails 40 of the first window regulator 22 and the distal end 76d of the cable 76 is coupled to the cable 42 of the first window regulator 22 proximate the first window pane 18.

The microprocessor 70 is electrically coupled to the slider rheostat switch 60, the cable pull potentiometer 68, the relay unit 72 and the upper and lower limit switches 48 and 50. The microprocessor 70 monitors the input switch signal, the cable displacement signal and the upper and lower limit switch signals to determine whether the relay unit 72 should be actuated. As the motors 46 of the first and second window regulators 22 and 24 are coupled to the relay unit 72, the microprocessor 70 may be used to control the position of both the first and second window panes 18 and 20. In one basic form, the relay unit 72 includes a plurality of normally open relays 80, each of which being coupled at one end to a power source, such as the vehicle battery 82, and to one of the plurality of wires that make up one of the wire harnesses 52 at the other end. The normally open relays 80 are coupled to the microprocessor 70 which controls the relays 80 to selectively close one or more of the relays 80 to permit electrical power to flow to one or more of the motors 46. For example, relay 80a would cause operation of a motor in one direction, and 80b would cause operation of the same motor in the opposite direction. Likewise relays 80c and 80d would cause bidirectional operation of a second motor.

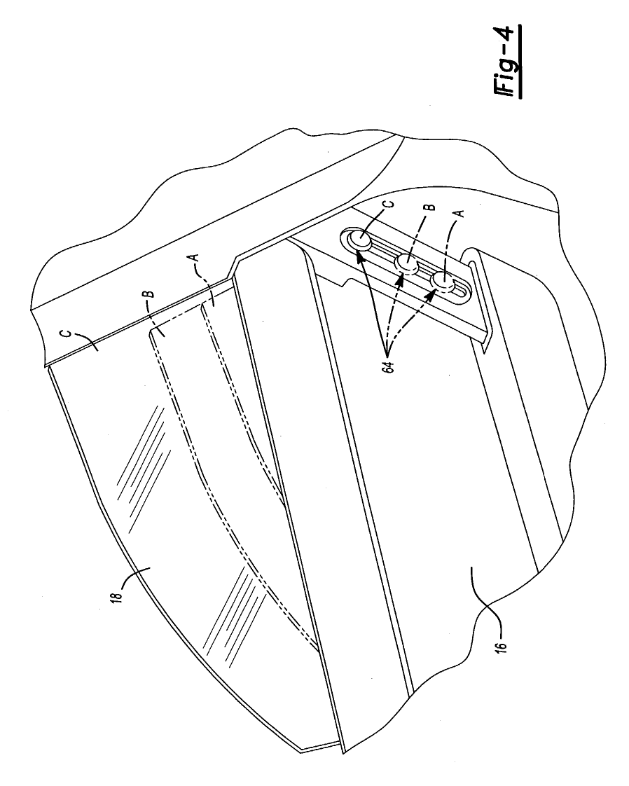

In accordance with the present invention, FIG. 4 illustrates positioning/movement of the first window pane 18 in proportion or correlation to the position of the slider knob 64. More specifically, positioning of knob 64 as shown at A causes the window to automatically be moved to position A′. Likewise for positions B/B′ and C/C′. Accordingly, microprocessor 70 is operable for determining an anticipated cable displacement based on the input signal provided by the slidable switch mechanism, comparing the anticipated cable displacement to the cable displacement signal and controlling the relay unit 72 to responsively move the first and second window panes 18 and 20 until a position corresponding to the anticipated cable displacement is achieved.

While the invention has been described in the specification and illustrated in the drawings with reference to a preferred embodiment, it will be understood by those skilled in the art that various changes may be made and equivalents may be substituted for elements thereof without departing from the scope of the invention as defined in the claims. In addition, many modifications may be made to adapt a particular situation or material to the teachings of the invention without departing from the essential scope thereof. Therefore, it is intended that the invention not be limited to the particular embodiment illustrated by the drawings and described in the specification as the best mode presently contemplated for carrying out this invention, but that the invention will include any embodiments falling within the foregoing description and the appended claims.

What is claimed is:

1. A control arrangement for a power window in a vehicle, the arrangement comprising:
a window regulator mechanism having at least one motor and a structure that is configured to move a window between fully-open and fully-closed positions;
a switch having a input member translatable by an occupant in the vehicle between respective end positions, wherein the switch is arranged to produce a signal indicative of the relative position of the translatable input member; and
a controller coupled to the switch and the window regulator mechanism, the controller being configured to control operation of the window regulator mechanism in response to the switch signal such that window is moved to a position correlated to the relative position of the translatable input member.

2. The control arrangement of claim 1 wherein the translatable input member comprises a knob slidable along a track.

3. The control arrangement of claim 1 wherein the controller is configured to control positioning of the window such that the window is moved to: (a) the fully-closed position when the translatable input member is positioned at one end position, (b) the fully-open position when the translatable input member is positioned at the other end position, and (c) a intermediate position between the fully-open and fully-closed positions proportional to the position of the translatable input member between the end positions.

4. The control arrangement of claim 1 wherein the translatable input member comprises a knob coupled to a rotatable shaft.

5. The control arrangement of claim 1 wherein the controller comprises a microprocessor responsive to the switch signal and a window position detection arrangement, wherein the window position detection arrangement includes upper and lower limit switches, and a window position transducer operable for generating a signal indicative of window position.
